(19) United States
(12) Patent Application Publication
(10) Pub. No.: US 2010/0078946 A1
(43) Pub. Date: Apr. 1, 2010

(54) REAR GATE HANDLE FOR VEHICLES

(76) Inventor: Yu-Chih Sun, Taipei Hsien (TW)

Correspondence Address: HANLEY, FLIGHT & ZIMMERMAN, LLC, 150 S. WACKER DRIVE, SUITE 2100, CHICAGO, IL, 60606, US

(21) Appl. No.: 12/240,571

(22) Filed: Sep. 29, 2008

(51) Int. Cl. E05B 3/00

(52) U.S. Cl. 292/336.3

(57) ABSTRACT

A rear gate handle is pivotally mounted on a back of a vehicle having an in-house line and has a middle, a handle panel and a multifunctional luminescent device. The handle panel is mounted on the back door near the middle and has a mounting recess. The multifunctional luminescent device is attached to the handle panel and has a base, a light bar and a cover. The base is mounted in the mounting recess and has a chamber and an opening. The light bar is mounted in the chamber of base and is electrically connected to the in-house line of the vehicle. The cover is detachably mounted on the base.

### BACKGROUND OF THE INVENTION

1. Field of the Invention

The present invention relates to a rear gate handle, and more particularly to a rear gate handle with an indicative lamp device for a vehicle that can provide an indicative effect.

2. Description of Related Art

Conventional vehicles usually have an indicative lamp device such as taillights or brake lights mounted on the sides or the top of a back door to indicate a driver's actions to following vehicles. An auxiliary brake light may also be mounted on the top of the back door for improved safety.

Although, the conventional indicative lamp device can provide an indicative effect to the rear vehicle. When the conventional vehicles are driven in rainy, snowy, foggy conditions or at night, the rear vehicle cannot distinguish the driving situation of the front vehicle in a short distance by the conventional indicative lamp device on the sides, the bottom or the top of the back door and may lead to a traffic accident and cannot provide special knowledge for following cars.

To overcome the shortcomings, the present invention provides a rear gate handle with an indicative lamp device for a vehicle to mitigate or obviate the aforementioned problems.

### SUMMARY OF THE INVENTION

The main objective of the present invention is to provide a rear gate handle for a vehicle that can provide an indicative effect.

The rear gate handle for a vehicle in accordance with the present invention is pivotally mounted on a back of a vehicle having an in-house line and has a middle, a handle panel and a multifunctional luminescent device. The handle panel is mounted on the back door near the middle and has a mounting recess. The multifunctional luminescent device is attached to the handle panel and has a base, a light bar and a cover. The base is mounted in the mounting recess and has a chamber and an opening. The light bar is mounted in the chamber of the base and is electrically connected to the in-house line of the vehicle. The cover is detachably mounted on the base.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a rear gate handle in accordance with the present invention mounted on a vehicle back door;

FIG. 2 is an enlarged perspective view of the rear gate handle in FIG. 1;

FIG. 3 is an exploded perspective view of the rear gate handle in FIG. 1;

FIG. 4 is a top view in partial section of the rear gate handle in FIG. 1; and

FIG. 5 is a simplified block diagram of a light bar of the rear gate handle in FIG. 1 connected to an in house line of a vehicle.

### DETAILED DESCRIPTION OF THE PREFERRED EMBODIMENT

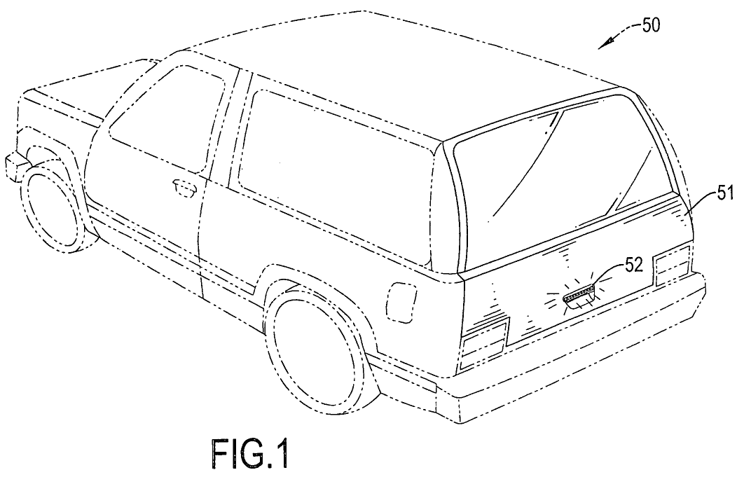

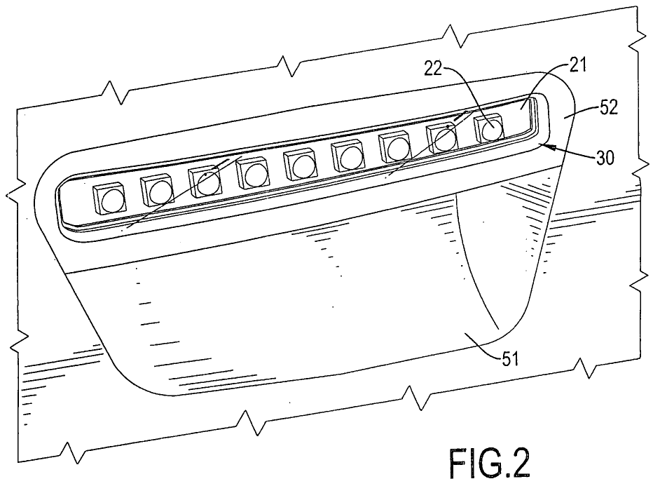

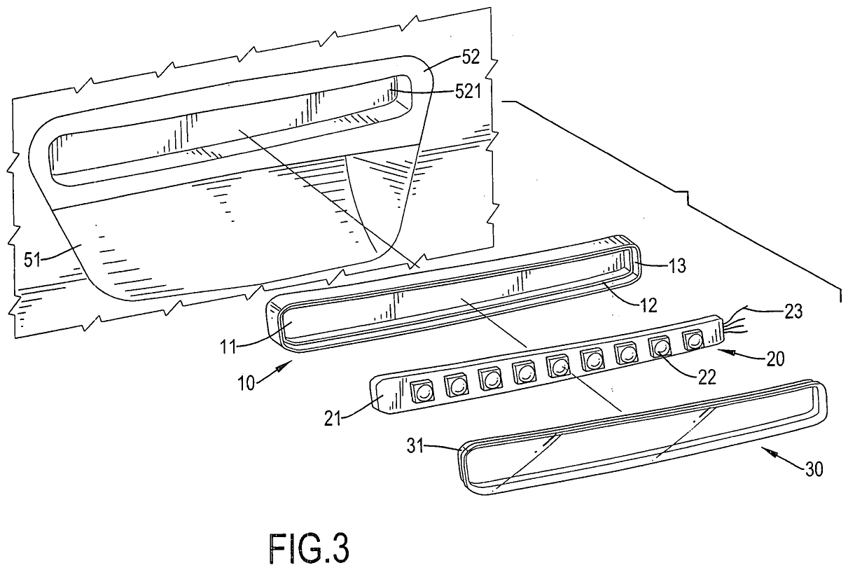

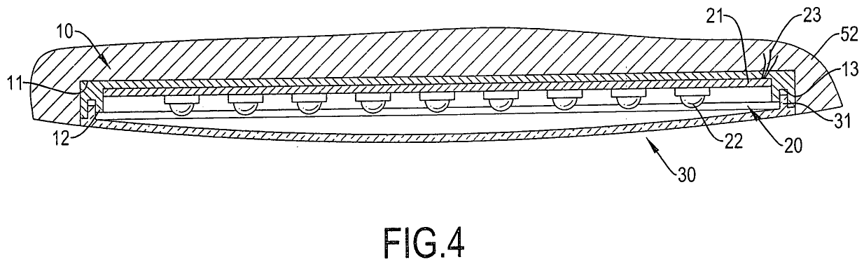

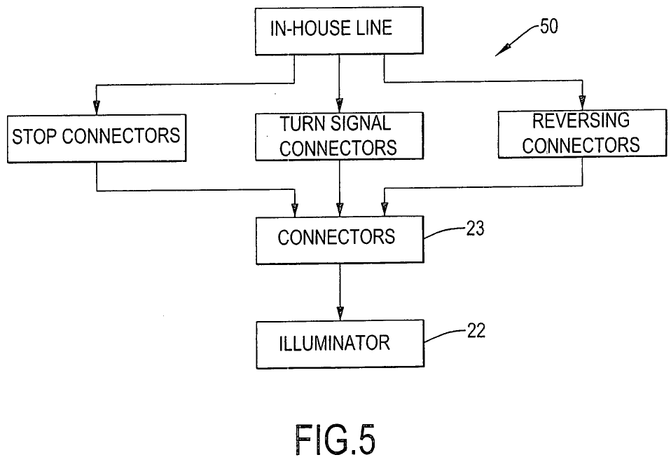

With reference to FIGS. 1 to 5, a rate gate (51) or a back door or a tail gate in accordance with the present invention is pivotally mounted on a back of a vehicle (50) having an in-house line with multiple stop connectors, multiple turn signal connectors, multiple reversing connectors and comprises a middle, an external surface, a handle panel (52) and a multifunctional luminescent device.

The handle panel (52) is mounted on the external surface of the rate gate (51) near the middle and has an external surface, a mounting recess (521) and an optional lever. The mounting recess (521) is formed in the external surface of the handle panel (52). The lever may be mounted in the handle panel (52) or may be mounted pivotally to the handle panel (52) and mounted securely on the vehicle (50) to release a locking mechanism of the rear gate (51).

The multifunctional luminescent device is attached to the handle panel (52) and has a base (10), a light bar (20) and a cover (30). The multifunctional luminescent device may be formed in the handle panel (52).

The base (10) is mounted in the mounting recess (521) of the handle panel (52) and has an outer side, a chamber(11), an opening(12), an optional rim and an optional shoulder (13). The chamber (11) is defined in the base (10). The opening (12) is formed through the outer side of the base (10) and communicates with the chamber (11) of the base (10). The rim is formed around the opening (12). The shoulder (13) is formed adjacent to the rim.

The light bar (20) is mounted in the chamber of the base (10) and has a light panel (21), at least one illuminator (22) and multiple connectors (23). The light panel (21) is mounted in the chamber (11) of the base (10) and has an external surface. The at least one illuminator (22) is mounted on the external surface of the light panel (21) and may be a light-emitting diode, an incandescent bulb, a halogen light, an electroluminescent panel or the like. Tie connectors (23) are electrically connected to the at least one illuminator (22) and are electrically connected to the in-house line of the vehicle (50). The connectors (23) may be connected to stop connectors of the vehicle (50) to act as extra stop lights, connected to turn signal connectors of the vehicle (50) to act as extra turn signal lights, connected to the reversing connectors of the vehicle (50) to act as extra reverse lights or the like.

The cover (30) is translucent, is detachably mounted on the base (10) to cover the light bar (20) in the base (10) and has an optional mounting ring (31). The mounting ring (31) is formed around the cover (30) and abuts the shoulder (13) of the base (10).

When installed on the rear gate (51) of the vehicle (50), the multifunctional luminescent device can obviously offer improved light signals, improve night and poor-visibility illumination of the vehicle (50) or an aesthetic appeal of the vehicle (50). Therefore, in poor-visibility conditions such as rain, snow, fog and at night the traffic accidents may be reduced.

Even though numerous characteristics and advantages of the present invention have been set forth in the foregoing description, together with details of the structure and features of the utility model, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A rear gate handle for a vehicle having an in-house line with multiple stop connectors, multiple turn signal connectors and multiple reversing connectors and the rear gate handle having
a middle;
an external surface;
a handle panel mounted on the external surface of the rear gate handle near the middle and having
an external surface; and
a mounting recess being formed in the external surface of the handle panel; and
a multifunctional luminescent device being attached to the handle panel and having
a base being mounted in the mounting recess of the handle panel and having
an outer side;
a chamber being defined in the base; and
an opening being formed through the outer side of the base and communicating with the chamber of the base;
a light bar being mounted in the chamber of the base and having
a light panel being mounted in the chamber of the base and having an external surface;
at least one illuminator being mounted on the external surface of the light panel; and
multiple connectors being electrically connected to the at least one illuminator and being adapted to electrically connect to the in-house line of the vehicle; and
a cover being detachably mounted on the base to cover the light bar in the base.

2. The rear gate handle for a vehicle as claimed in claim 1, wherein
the base further has
a rim being formed around the opening; and
a shoulder being formed adjacent to the rim; and
the cover further has a mounting ring being formed around the cover and abutting the shoulder of the base.

3. The rear gate handle for a vehicle as claimed in claim 2, wherein the cover is made of a translucent material.

4. The rear gate handle for a vehicle as claimed in claim 3, wherein the connectors of the light bar are adapted to connect to stop connectors of the vehicle.

5. The rear gate handle for a vehicle as claimed in claim 3, wherein the connectors of the light bar are adapted to connect to turn signal connectors of the vehicle.

6. The rear gate handle for a vehicle as claimed in claim 3, wherein the connectors of the light bar are adapted to connect to the reversing connectors of the vehicle.

7. The rear gate handle for a vehicle as claimed in claim 1, wherein each illuminator is a light-emitting diode.

8. The rear gate handle for a vehicle as claimed in claim 1, wherein each illuminator is a light bulb.

9. The rear gate handle for a vehicle as claimed in claim 1, wherein each illuminator is an electroluminescent panel.

10. The rear gate handle for a vehicle as claimed in claim 1, wherein each illuminator is a light panel.
